(19) United States
(12) Patent Application Publication
(10) Pub. No.: US 2015/0280630 A1
(43) Pub. Date: Oct. 1, 2015

(54) POWER GENERATION CONTROL APPARATUS FOR GENERATOR AND POWER GENERATION CONTROL METHOD OF GENERATOR

(71) Applicant: TOYOTA JIDOSHA KABUSHIKI KAISHA, Toyota-shi, Aichi-ken (JP)

(72) Inventor: Taejin Yoon, Toyota-shi (JP)

(73) Assignee: TOYOTA JIDOSHA KABUSHIKI KAISHA, Toyota-shi, Aichi-ken (JP)

(21) Appl. No.: 14/435,239

(22) PCT Filed: Nov. 30, 2012
(86) PCT No.: PCT/JP2012/007692

§ 371 Date: Apr. 13, 2015

(51) Int. Cl. H02P 9/30; H02P 9/48

(52) U.S. Cl. CPC H02P 9/305; H02P 9/48

(57) ABSTRACT

A vehicle 10 stores in advance, in a memory 210, an allowable voltage V as a range in which a feeling of strangeness on the basis of an output variation is acceptable, with respect to each of electrical load devices E1 to EN including headlights 21 and a windshield wiper motor 31 mounted on the vehicle 10. The vehicle 10 identifies output requesting electrical devices, which a vehicle operator requires outputs, in response to the vehicle operator's switch operations, reads the allowable voltages V of the identified output requesting electrical load devices from the memory 210, and sets an overlap voltage range in which the read allowable voltages V are overlapped, to a power generation voltage range Vp for power generation control of a generator 60. The vehicle 10 then limits the power generation voltage of the generator 60 to the power generation voltage range Vp and performs power generation control of the generator 60.

### TECHNICAL FIELD

The present invention relates to a power generation control apparatus for a generator and a power generation control method of a generator.

### BACKGROUND ART

The power generation voltage of a generator is supplied to various electrical load devices. For example, the power generation voltage of a generator mounted on a vehicle is supplied to various lighting devices such as headlights of the vehicle, a vehicle interior light and a instrument illumination light for an instrument panel, as well as to various drive devices such as drive motors for a windshield wiper and blowers. The output of each of the electrical load devices including the lighting device and the drive devices is varied with a variation in power generation voltage of the generator as the supplied voltage. More specifically, the lighting device has a variation in light quantity, and the drive device has a variation in driving speed. The output variation of the lighting device accompanied with a variation in power generation voltage is likely to be recognized as flicker and is likely to give a feeling of strangeness. One proposed technique for reducing such a feeling of strangeness differs a variation width of the power generation voltage between the lighting time of the headlights and the non-lighting time of the headlights and sets a smaller variation width of the power generation voltage at the lighting time of the headlights (for example, PTL 1). The output variation of the drive device accompanied with a variation in power generation voltage is likely to be recognized as an operation failure or an abnormal operating noise and is likely to give a feeling of strangeness.

### CITATION LIST

### Patent Literature

PTL 1: JP 2002-369403A

Other than the headlights, there are plurality of electrical load devices configured to receive supply of the power generation voltage of the generator. In many cases, all or part of the electrical load devices may be used simultaneously. The respective electrical load devices have different power consumption configurations and output configurations based on their functions to be achieved. This accordingly differs the occurrence of an output variation accompanied with a variation in power generation voltage among the respective electrical load devices, and additionally differs the bandwidth of a variation in power generation voltage leading to an output variation that is likely to give a feeling of strangeness among the respective electrical load devices. The proposed power generation voltage control taking into account the difference between the lighting time and the non-lighting time of the headlights is thus expected to insufficiently reduce a feeling of strangeness on the basis of an output variation with respect to the electrical load devices other than the headlights. Other needs include simplified power generation control for a generator, suppression of an increase in total number of parts and an increase in total weight by using a specific control device, and cost reduction.

In order to solve at least part of the problems described above, the invention may be implemented by the following aspects.

### SUMMARY

(1) According to one aspect of the invention, a power generation control apparatus for a generator is provided. The power generation control apparatus for the generator comprises: a plurality of electrical load devices to which a power generation voltage of the generator is applied, respectively; a storage unit configured to store an allowable voltage range set for each of the electrical load devices as a range in which voltage application to the electrical load device is allowed; a device identifier configured to identify each application object electrical load device as an object of voltage application, among the plurality of electrical load devices; an overlap range calculator configured to read the allowable voltage range of each identified application object electrical load device from the storage unit and calculate an overlap voltage range in which the read allowable voltage ranges of the application object electrical load devices are overlapped; and a power generation controller configured to limit the power generation voltage of the generator to the overlap voltage range and perform power generation control of the generator. The power generation control apparatus for the generator according to this aspect of the invention applies the power generation voltage of the generator, which is limited to the overlap voltage range narrower than the allowable voltage ranges of the respective application object electrical load devices, to the application object electrical load devices. This enables an output variation of each of the application object electrical load devices to be limited to an allowable output variation range specified corresponding to the allowable voltage range. As a result, this configuration reduces a feeling of strangeness on the basis of an output variation with respect to all the application object electrical load devices as objects of output requirement. Additionally, this configuration does not need any specific device for suppression of a variation in applied voltage with respect to each of the application object electrical load devices as the objects of output requirement. This suppresses an increase in total number of parts and an increase in total weight and is advantageous in cost. The power generation control apparatus for the generator according to the above aspect of the invention may be mounted on a vehicle and enable a charger to be stably charged with the stable power generation voltage limited to the overlap voltage range. This improves the availability ratio of charge control and, in combination with suppression of an increase in weight described above, improves the fuel consumption. In the process of limiting the power generation voltage to the overlap voltage range, the power generation voltage may be limited to the entire overlap voltage range from its lower limit to its upper limit or may be limited to a partial range included in the overlap voltage range.

(2) In the power generation control apparatus for the generator according to the above aspect, in the event the overlap range calculator is unable to calculate of the overlap voltage range, the power generation controller may limit the power generation voltage of the generator to a predetermined voltage range and perform power generation control of the generator. This configuration may reduce a feeling of strangeness on the basis of an output variation with respect to each electrical load device having an overlap voltage range consistent with the predetermined voltage range, which the power generation voltage of the generator is limited to. Additionally, this configuration does not apply a large load to the generator and thus enhances the power generation efficiency.

(3) In the power generation control apparatus for the generator according to the above aspect, the storage unit may store a priority for suppression of an output variation set with respect to each of the electrical load devices. In the event the overlap range calculator is unable to calculate the overlap voltage range, the overlap range calculator may read the priority set for each application object electrical load device from the storage unit, exclude the application object electrical load device having a low priority from calculation of the overlap voltage range and calculate the overlap voltage range. This configuration reduces a feeling of strangeness on the basis of an output variation with respect to each electrical load device having the high priority for suppression of the output variation.

(4) According to another aspect of the invention, a power generation control apparatus for a generator is provided. The power generation control apparatus for the generator comprises: a plurality of electrical load devices to which a power generation voltage of the generator is applied, respectively; a storage unit configured to store a change rate range of allowable voltage set for each of the electrical load devices as a range in which application of varying voltage to the electrical load device is allowed; a device identifier configured to identify each application object electrical load device as an object of voltage application, among the plurality of electrical load devices; a low change rate range selector configured to read the change rate range of allowable voltage with respect to each identified application object electrical load device from the storage unit and select a lowest change rate range among the read change rate ranges of allowable voltage of the application object electrical load devices, as a selected change rate range; and a power generation controller configured to limit a change rate of the power generation voltage of the generator to the selected change rate range and perform power generation control of the generator. The power generation control apparatus for the generator according to this aspect of the invention allows for a change in power generation voltage of the generator only at the change rate limited to the selected change rate range. This configuration enables an output variation of each application object electrical load device under application of the power generation voltage to be limited to an allowable output variation range corresponding to the change rate range of allowable voltage with respect to the application object electrical load device. As a result, this configuration reduces a feeling of strangeness on the basis of an output variation with respect to all the application object electrical load devices as objects of output requirement.

(5) According to another aspect of the invention, a power generation control method of a generator is provided. The power generation control method of the generator comprises steps of (1) identifying each application object electrical load device as an object of voltage application, among a plurality of electrical load devices to which a power generation voltage of the generator is applied, respectively; (2) reading an allowable voltage range of each application object electrical load device identified in the step (1) from a storage unit configured to store the allowable voltage range set for each of the electrical load devices as a range in which voltage application to the electrical load device is allowed, and calculating an overlap voltage range in which the read allowable voltage ranges of the application object electrical load devices are overlapped; and (3) limiting the power generation voltage of the generator to the overlap voltage range calculated by the overlap range calculator and performing power generation control of the generator. The power generation control method of the generator according to this aspect of the invention applies the power generation voltage of the generator, which is limited to the overlap voltage range narrower than the allowable voltage ranges of the respective application object electrical load devices, to the application object electrical load devices. This enables an output variation of each of the application object electrical load devices to be limited to an allowable output variation range specified corresponding to the allowable voltage range. As a result, this configuration reduces a feeling of strangeness on the basis of an output variation with respect to all the application object electrical load devices as objects of output requirement.

The invention may also be applicable to a vehicle equipped with a generator and its power generation control apparatus.

### BRIEF DESCRIPTION OF DRAWINGS

FIG. 1 is a diagram schematically illustrating a vehicle 10 equipped with various electrical load devices according to one embodiment of the invention;

FIG. 2 is a block diagram illustrating the electrical configuration of the vehicle 10 including a controller 200;

FIG. 3 is a diagram illustrating minimum allowable voltages Vmin and maximum allowable voltages Vmax of allowable variation ranges with respect to respective electrical load devices;

FIG. 4 is a functional block diagram illustrating an electrical load input adjuster 220 and a generator voltage command provider 230;

FIG. 5 is a flowchart showing a power generation control process of a generator 60;

FIG. 6 is diagrams illustrating calculation of an overlap of allowable voltage ranges when an electrical load device E1, an electrical load device E2 and an electrical load device EN are identified as output requesting electrical devices;

FIG. 7 is diagrams illustrating calculation of an overlap of allowable voltage ranges when the electrical load device E1, an electrical load device E3 and an electrical load device EN−2 are identified as output requesting electrical devices; and

FIG. 8 is diagrams illustrating calculation of an overlap of allowable voltage ranges in an embodiment that provides high-low priorities for suppression of an output variation.

### DESCRIPTION OF EMBODIMENTS

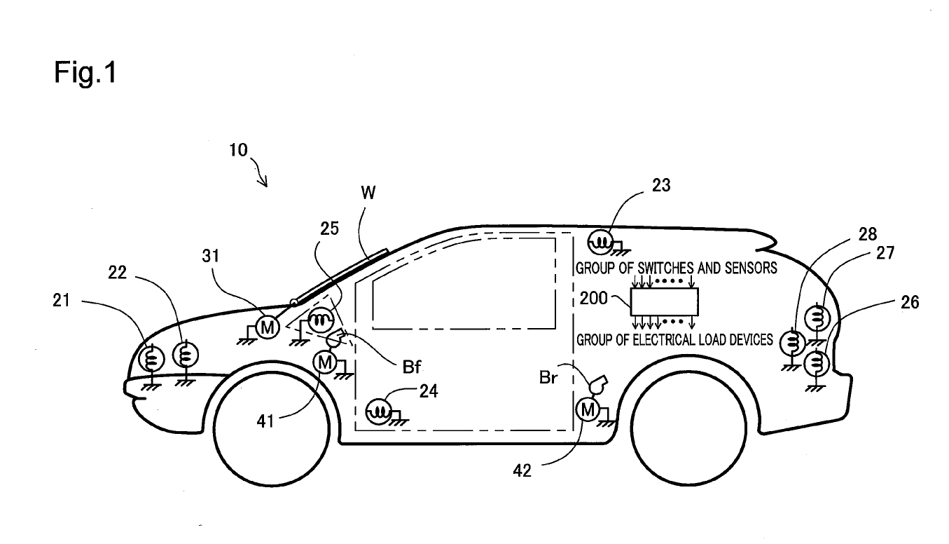

The following describes embodiments of the invention with reference to the drawings. FIG. 1 is a diagram schematically illustrating a vehicle 10 equipped with various electrical load devices according to one embodiment of the invention. The vehicle 10 has a plurality of lighting devices and a plurality of drive devices as electrical load devices that are output request objects, as described below. The vehicle 10 has headlights 21, front turn signal lamps 22 including width indicators, a instrument illumination light 25, door illumination lamps 24, a vehicle interior light 23, rear turn signal lamps 26, brake lamps 27 and tail lamps 28 including width indicators and a backup light which are located from the vehicle front side, as the plurality of lighting devices. These lights and lamps are subjected to lighting control by a controller 200 (described later), in response to the driver's or vehicle operator's switching operations and device operations. Among these lights and lamps, the respective lights and lamps except the vehicle interior light 23 and the instrument illumination light 25 are provided on both the left side and the right side of the vehicle and are respectively turned on and off. The vehicle 10 also has a windshield wiper motor 31, a front blower motor 41 and a rear blower motor 42, as the plurality of drive devices. The windshield wiper motor 31 is connected with windshield wipers W to drive the windshield wipers W under control of the controller 200. The front blower motor 41 drives a front blower Bf under control of the controller 200 to blow the air from the front blower Bf. The rear blower motor 42 drives a rear blower Br under control of the controller 200 to blow the air from the rear blower Br. The lighting devices and the drive devices described above are only some examples of the electrical load devices mounted on the vehicle 10, and any other lighting devices and drive devices may be included as control objects of a power generation control process described later. For example, when the vehicle 10 is a four-door vehicle, the lighting devices may include back door illumination lamps. In the vehicle 10 equipped with a power-driven sheet adjustment mechanism, the drive devices may include motors for seat front-back position adjustment and seat inclination adjustment.

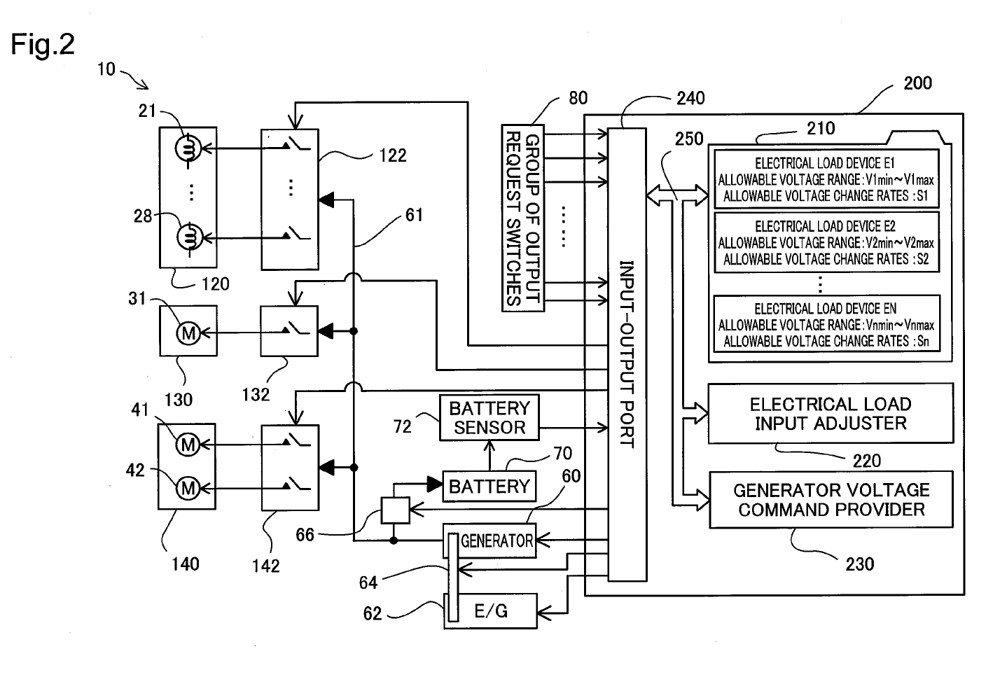

The controller 200 is implemented by a microcomputer including, for example, a CPU that performs logic operations, a ROM and a RAM. The controller 200 serves to receive signals from, for example, switches of illumination lights and a brake sensor (not shown) and control the respective lighting devices and the drive devices above. FIG. 2 is a block diagram illustrating the electrical configuration of the vehicle 10 including the controller 200.

As illustrated, the controller 200 is connected with a group of output request switches 80 and inputs on signals and off signals from the respective switches included in the group of output request switches 80 via an input-output port 240. The switches included in the group of output request switches 80 are, for example, lighting switches of various illumination lights such as the headlights 21, a windshield wiper switch, an air blower switch and a brake switch. The controller 200 is also connected via the input-output port 240 with a generator 60, an engine 62, a rotation transmission device 64, a charge/power feed device 66, and a battery sensor 72 and actuates an electrical load input adjuster 220 and a generator voltage command provider 230 (described later) in a cooperative manner to perform power generation control of the generator 60 or more specifically drive control of the engine 62 and driving force transmission control by the rotation transmission device 64. These controls will be described later. The controller 200 detects the charge-discharge state of the battery 70 in response to the output of the battery sensor 72 and, on requirement for charging, controls the charge/power feed device 66 to charge the battery 70 with the electric power generated by the generator 60.

The generator 60 generates electric power and supplies the generated electric power to, for example, the headlights 21, under control of the controller 200. For the purpose of supplying the electric power generated by the generator 60, the vehicle 10 has a lighting device group 120 including the illumination lights such as the headlights 21 and the tail lamps 28, a first drive device group 130 including the windshield wiper motor 31, a second drive device group 140 including the front blower motor 41 and the rear blower motor 42, a lighting device relay box 122, a first drive device relay box 132 and a second drive device relay box 142. The lighting device relay box 122 includes relays provided corresponding to the respective lighting devices included in the lighting device group 120 and switches over the respective relays between electrical continuity and no electrical continuity under control of the controller 200. The first drive device relay box 132 includes a relay provided corresponding to the windshield wiper motor 31 included in the first drive device group 130 and switches over the relay between electrical continuity and no electrical continuity under control of the controller 200. The second drive device relay boxy 142 includes relays provided corresponding to the front blower motor 41 and the rear blower motor 42 included in the second drive device group 140 and switches over the respective relays between electrical continuity and no electrical continuity under control of the controller 200.

The controller 200 connected with the headlights 21 and the others includes a memory 210, the electrical load input adjuster 220, the generator voltage command provider 230 and the input-output port 240, which are interconnected via a bus 250 in such a manner as to allow for mutual transmission of signals. The memory 210 is configured to store information in a non-transitory manner and stores an allowable voltage V and an allowable voltage change rate S with respect to each of the plurality of lighting devices such as the headlights 21 and the plurality of drive devices such as the windshield wiper motor 31 described above, which are respectively specified as electrical load devices E1 to EN.

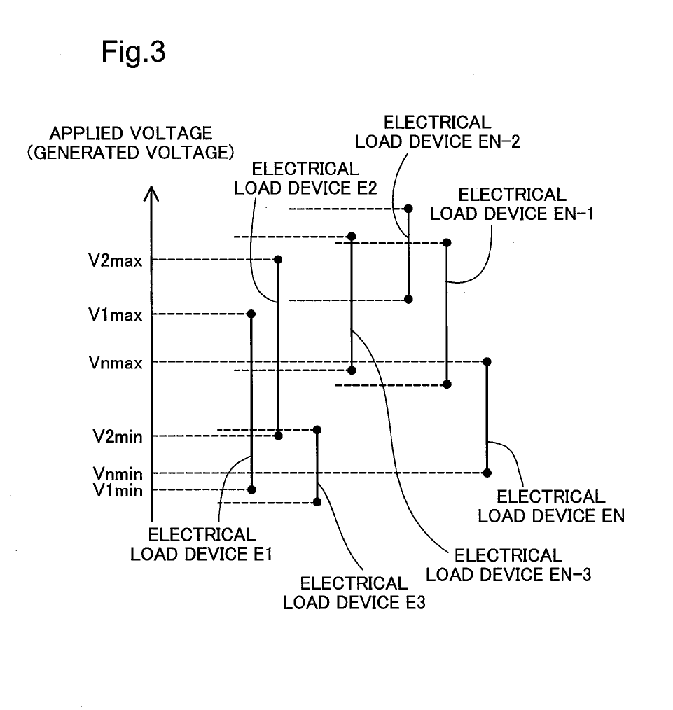

The allowable voltage V is specified as a range between a minimum allowable voltage Vmin and a maximum allowable voltage Vmax. This specified range with respect to a specific electrical load device is determined in advance as an allowable variation range, for example, in which a feeling of strangeness on the basis of a fluctuation of light quantity (flicker) caused by a variation in lighting output is acceptable for the vehicle operator when the headlights 21 as the electrical load device E1 are turned on. The specified range is also determined in advance as an allowable variation range in which a feeling of strangeness on the basis of a variation in driving speed of the windshield wipers W caused by a variation in motor output is acceptable for the vehicle operator when the windshield wipers W are driven by the windshield wiper motor 31 as the electrical load device Ei. The specified range is also determined in advance as an allowable variation range in which a feeling of strangeness on the basis of a variation in air flow caused by a variation in motor output is acceptable for the vehicle operator when the blower is actuated to blow the air by the front blower motor 41 or the rear blower motor 42 as another electrical load device. FIG. 3 is a diagram illustrating the minimum allowable voltages Vmin and the maximum allowable voltages Vmax of the allowable variation ranges with respect to respective electrical load devices. The memory 210 stores the minimum allowable voltages Vmin and the maximum allowable voltages Vmax of the allowable voltages V shown in FIG. 3, with respect to the electrical load devices E1 to EN (including, for example, the headlights 21 and the windshield wiper motor 31).

The allowable voltage change rate S is determined in advance as an allowable voltage change rate, for example, at which a feeling of strangeness on the basis of a fluctuation of light quantity (flicker) caused by a rate change of applied voltage is acceptable for the vehicle operator when the headlights 21 are turned on with the varying voltage applied to the headlights 21. The allowable voltage change rate S is also determined in advance as an allowable voltage change rate at which a feeling of strangeness on the basis of a variation in driving speed of the windshield wipers W caused by a rate change of applied voltage is acceptable for the vehicle operator when the windshield wipers W are driven by the windshield wiper motor 31 as a drive device. The allowable voltage change rate S is also determined in advance as an allowable voltage change rate at which a feeling of strangeness on the basis of a variation in air flow caused by a rate change of applied voltage is acceptable for the vehicle operator when the blower is actuated to blow the air by the front blower motor 41 or the rear blower motor 42 as another electrical load device. Like the allowable voltage V, the allowable voltage change rate S may be specified as a range between a minimum allowable change rate Smin and a maximum allowable change rate Smax. According to this embodiment, for the simplicity of the arithmetic operation, the allowable voltage change rates S are specified as change rates with respect to the respective electrical load devices E1 to EN (including, for example, the headlights 21 and the windshield wiper motor 31). The memory 210 stores the allowable voltage change rates S with respect to the respective electrical load devices.

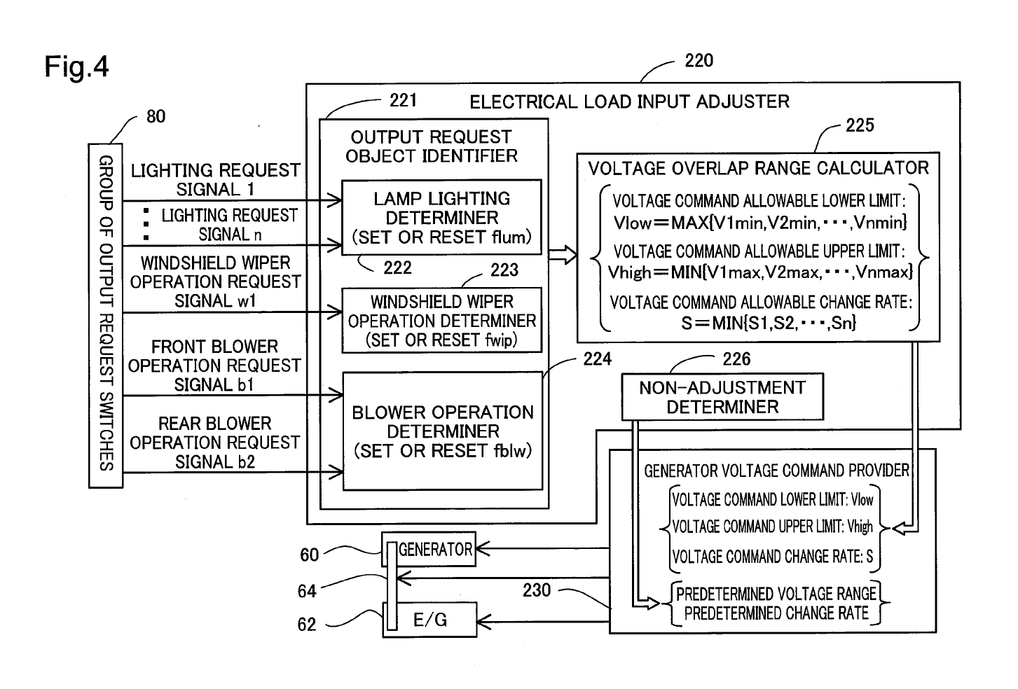

The electrical load input adjuster 220 and the generator voltage command provider 230 work in a cooperative manner to perform power generation control of the generator 60 and supply the generated electric power to the electrical load device such as the headlights 21 in response to a switching operation of a corresponding switch included in the group of output request switches 80. FIG. 4 is a functional block diagram illustrating the electrical load input adjuster 220 and the generator voltage command provider 230. As illustrated, the electrical load input adjuster 220 includes an output request object identifier 221, a voltage overlap range calculator 225 and a non-adjustment determiner 226. The output request object identifier 221 includes a lamp lighting determiner 222, a windshield wiper operation determiner 223 and a blower operation determiner 224. The lamp lighting determiner 222 receives the inputs of lighting request signals 1 to n from corresponding lighting switches included in the group of output request switches 80 and sets or resets a lamp flag flum with respect to each of the lighting devices, for example, the headlights 21, based on the state of each input signal. The lamp flag flum is set to light up a lighting device for which a lighting output is required by a corresponding switch signal and is output to the voltage overlap range calculator 225. The windshield wiper operation determiner 223 receives the input of a windshield wiper operation request signal w1 from a windshield wiper operation switch included in the group of output request switches 80 and sets or resets a windshield wiper flag fwi based on the state of the input signal. The windshield wiper flag fwi is set to actuate the wiper motor 31 for which a windshield wiper operation output is required by a corresponding switch signal and is output to the voltage overlap range calculator 225. The blower operation determiner 224 receives the inputs of operation request signals (air blow request signals) b1 and b2 from front and rear blower switches included in the group of output request switches 80 and sets or resets a blower flag fblw with respect to each of the front blower motor 41 and the rear blower motor 42, based on the state of each input signal. The blower flag fblw is set to drive the front blower Bf or the rear blower Br for which an air blow output is required by a corresponding switch signal and is output to the voltage overlap range calculator 225.

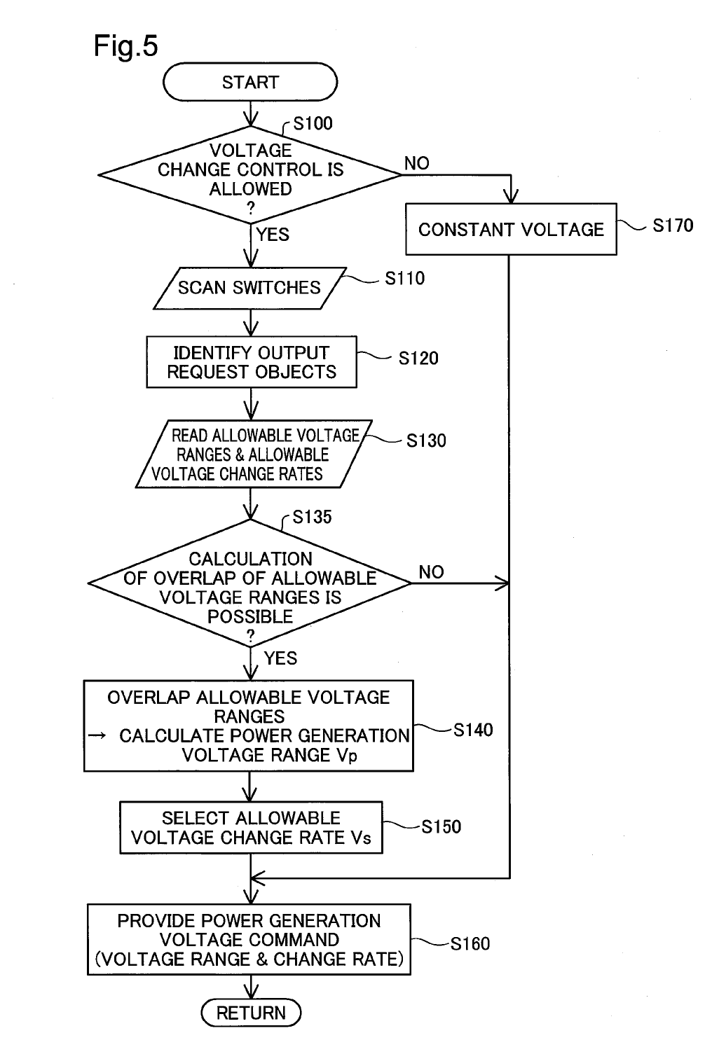

The voltage overlap range calculator 225 reads the minimum allowable voltages Vmin and the maximum allowable voltages Vmax of the allowable voltages V (shown in FIG. 3) and the allowable voltage change rates S with respect to the respective electrical load devices E1 to EN stored in the memory 210, and calculates a power generation voltage range Vp for power generation control of the generator 60 and a change rate Vs for voltage variation of the generator 60. The non-adjustment determiner 226 determines requirement or non-requirement for calculation of the power generation voltage range Vp and the change rate Vs of the generator 60, based on the charge-discharge state of the battery 70 and the presence or the absence of output requests from the switches included in the group of output request switches 80. The generator voltage command provider 230 limits the power generation voltage of the generator 60 to the power generation voltage range Vp calculated by the electrical load input adjuster 220, generates a command signal to vary the power generation voltage of the generator 60 at the change rate Vs, and outputs the command signal to the generator 60 to perform power generation control of the generator 60. The following describes power generation control of the generator 60 by the electrical load input adjuster 220 and the generator voltage command provider 230. FIG. 5 is a flowchart showing a power generation control process of the generator 60.

The illustrated power generation control process is performed repeatedly by the controller 200 at predetermined time intervals after an on operation of an ignition switch (not shown) of the vehicle 10. The controller 200 first determines whether the current state is the state that allows for voltage change control of the generator 60 or not (step S100). In the state that the charge power of the battery 70 (shown in FIG. 2) is exhausted or is insufficient, preference should be given to charging of the battery 70 and it is not advantageous to perform the voltage change control of the generator 60. Accordingly, the controller 200 detects the charge state of the battery 70 based on the output of the battery sensor 72 and determines whether the voltage change control of the generator 60 is allowed or not. The non-adjustment determiner 226 shown in FIG. 4 is involved in determining whether the voltage change control is allowed or not.

In response to an affirmative answer at step S110 that the voltage change control of the generator 60 is allowed, the controller 200 scans the respective switches included in the group of output request switches 80 (step S110), and identifies electrical load devices (output requesting electrical devices) for which the vehicle operator requires outputs, based on the result of scanning, in other words, based on the vehicle operator's switch operations (step S120). The output request object identifier 221 shown in FIG. 4 is involved in scanning the switches and identifying the output requesting electrical devices based on the result of scanning. One of the lamp flag flum, the windshield wiper flag fwi and the blower flag fblw may be set with respect to each of the output requesting electrical devices.

The controller 200 subsequently reads the minimum allowable voltages Vmin and the maximum allowable voltages Vmax of the allowable voltages V (shown in FIG. 3) and the allowable voltage change rates S with respect to the individual output requesting electrical devices for which the corresponding flags are set (step S130). The controller 200 determines whether calculation of an overlap of the ranges of the allowable voltages V is possible, based on the read minimum allowable voltages Vmin and maximum allowable voltages Vmax of the allowable voltages V with respect to the individual output requesting electrical devices (step S135). The following describes the processes of step S135 when three load devices, i.e., an electrical load device E1, an electrical load device E2 and an electrical load device EN, are identified at steps S110 and S120 as the output requesting electrical devices (in a first state) and when three load devices, i.e., the electrical load device E1, an electrical load device E3 and an electrical load device EN−2, are identified at steps S110 and S120 as the output requesting electrical devices (in a second state). The combination of the three electrical load devices differs in these states by the vehicle operator's switch operations. For example, the combination may be a combination of any three lighting devices out of the respective lighting devices such as the headlights 21 shown in FIG. 1, a combination of the respective motors, i.e., the windshield wiper motor 31, the front blower motor 41 and the rear blower motor 42, or a combination of any lighting devices and motors.

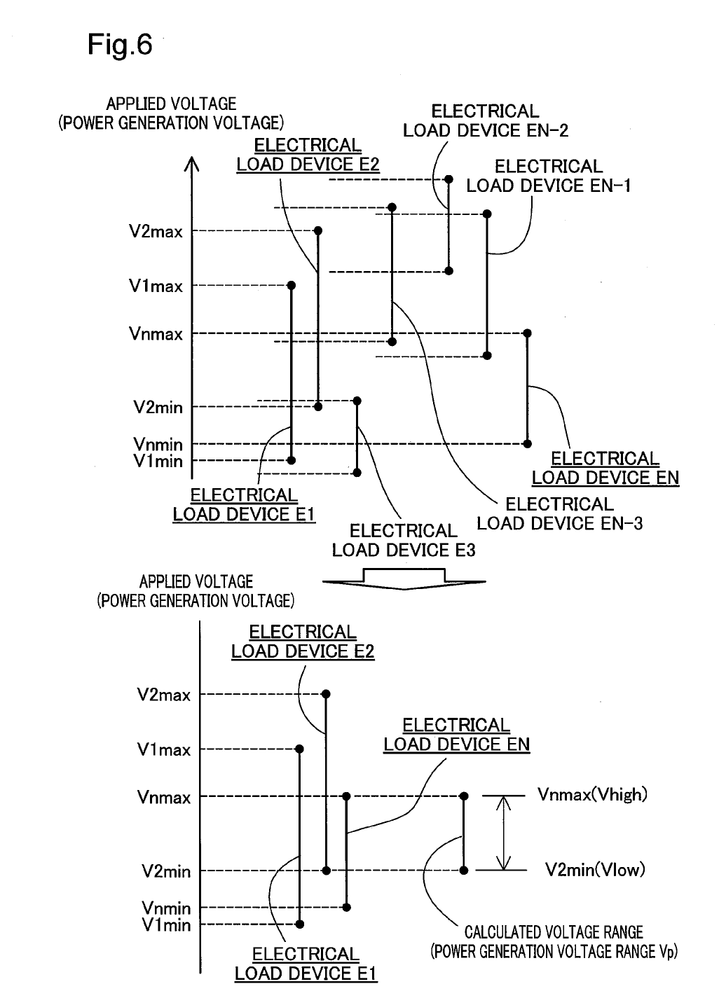

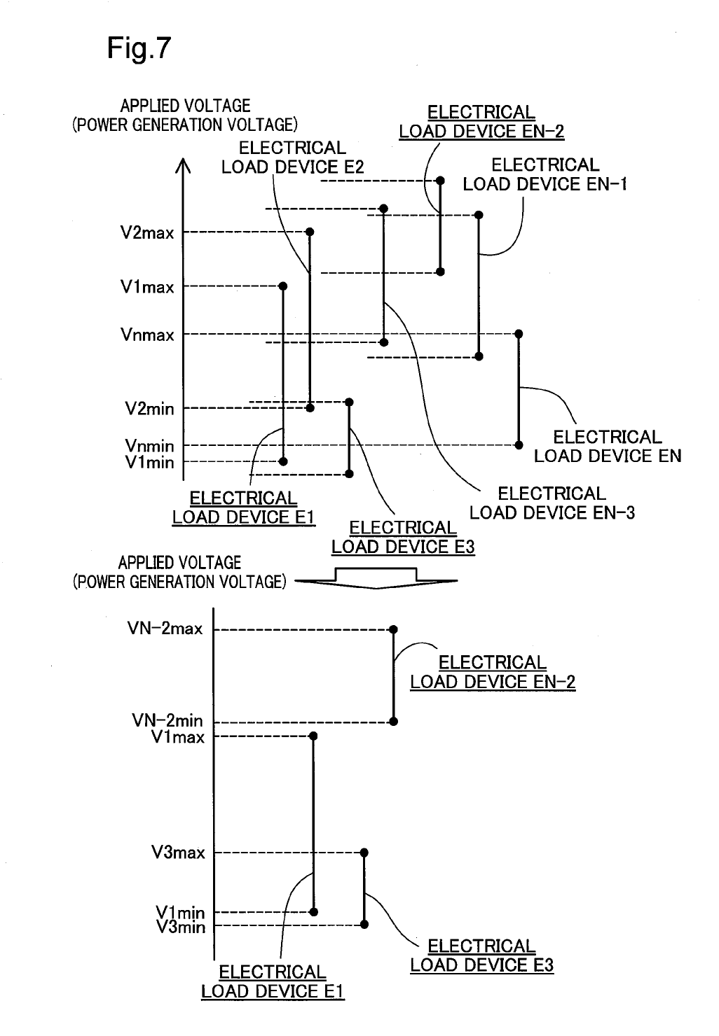

FIG. 6 is diagrams illustrating calculation of an overlap of allowable voltage ranges when the electrical load device E1, the electrical load device E2 and the electrical load device EN are identified as the output requesting electrical devices. FIG. 7 is diagrams illustrating calculation of an overlap of allowable voltage ranges when the electrical load device E1, the electrical load device E3 and the electrical load device EN−2 are identified as the output requesting electrical devices. The state of FIG. 6 is described first. In these diagrams, the electrical load devices identified as the output requesting electrical devices by the vehicle operator's switch operations are distinguished by underlines.

In the first state of FIG. 6, as shown by the lower diagram, there is a partial overlap of the ranges of the allowable voltages V read with respect to the electrical load device E1, the electrical load device E2 and the electrical load device EN. In the first state of FIG. 6, the controller 200 accordingly has an affirmative answer at step S135 and calculates the overlap range as a power generation voltage range Vp (step S140). The voltage overlap range calculator 225 shown in FIG. 4 is involved in calculating the power generation voltage range Vp. More specifically, the voltage overlap range calculator 225 sets the largest minimum allowable voltage Vmin among the minimum allowable voltages Vmin of the allowable voltages V with respect to the electrical load device E1, the electrical load device E2 and the electrical load device EN or specifically a minimum allowable voltage V2min with respect to the electrical load device E2 in this illustrated example, as a lower limit Vlow of the power generation voltage range Vp. The voltage overlap range calculator 225 also sets the smallest maximum allowable voltage Vmax among the maximum allowable voltages Vmax of the allowable voltages V with respect to the electrical load device E1, the electrical load device E2 and the electrical load device EN or specifically a maximum allowable voltage VNmax with respect to the electrical load device EN in this illustrated example, as an upper limit Vhigh of the power generation voltage range Vp. The voltage overlap range calculator 225 then specifies the range from the lower limit Vlow (=minimum allowable voltage V2min) to the upper limit Vhigh (=maximum allowable voltage VNmax) as the power generation voltage range Vp (step S140). The controller 200 subsequently selects a change rate Vs in the process of varying the power generation voltage of the generator 60, among the read allowable voltage change rates S with respect to the electrical load device E1, the electrical load device E2 and the electrical load device EN (step S150). The voltage overlap range calculator 225 shown in FIG. 4 is involved in selecting the change rate Vs. More specifically, the voltage overlap range calculator 225 selects a lowest allowable voltage change rate S among the read allowable voltage change rates S, as the change rate Vs.

After specifying the power generation voltage range Vp and the change rate Vs in response to the affirmative answer at step S135 as described above (steps S140 and S150), the controller 200 generators a power generation voltage command signal for the generator 60 and performs power generation control of the generator 60 based on the generated command signal (step S160). In this case, the power generation voltage command signal includes a control signal that limits the power generation voltage of the generator 60 to the power generation voltage range Vp (lower limit Vlow to upper limit Vhigh) specified at steps S140 and S150 and specifies a voltage change rate during power generation of the generator 60 with the varying voltage as the change rate Vs. Accordingly, the generator 60 is operated to generate electric power at the power generation voltage in the power generation voltage range Vp (lower limit Vlow to upper limit Vhigh) in the state of varying voltage at the change rate Vs and applies the power generation voltage to the electrical load device E1, the electrical load device E2 and the electrical load device EN identified as the output requesting electrical devices. The power generation voltage command signal is generated by the generator voltage command provider 230 shown in FIG. 4 and is output as a control signal to the generator 60.

In the second state of FIG. 7, on the other hand, as shown by the lower diagram, there is no overlap of the ranges of the overlap voltages V read with respect to the electrical load device E1, the electrical load device E3 and the electrical load device EN−2 identified as the output requesting electrical devices. Accordingly, in the second state of FIG. 7, the controller 200 has a negative answer at step S135 and proceeds to step S160. At step S160, irrespective of the allowable voltages V and the allowable voltage change rates S read with respect to the above respective electrical load devices, the controller 200 sets a predefined voltage range and a predefined change rate to the power generation voltage range Vp of the generator 60 and the change rate Vs for voltage change control and performs power generation control of the generator 60 based on a power generation voltage command signal corresponding to such setting. In this case, the power generation voltage command signal is generated by the generator voltage command provider 230 in response to determination of non-requirement for adjustment by the non-adjustment determiner 226 shown in FIG. 4 and is output as a control signal to the generator 60. When it is determined that the voltage change control of the generator 60 is not allowed based on the charge state of the battery 70 at step S100 in the power generation control process, the controller 200 sets a predefined voltage range and a predefined change rate to the power generation voltage range Vp of the generator 60 and the change rate Vs for voltage change control and performs power generation control of the generator 60 based on a power generation voltage command signal corresponding to such setting. The predefined voltage range and the predefined change rate are defined as a rated voltage range and a change rate suitable for the power generation performance of the generator 60.

As described above, the vehicle 10 of the embodiment stores in advance in the memory 210, the minimum allowable voltages Vmin and the maximum allowable voltages Vmax of the allowable voltages V (shown in FIG. 3) and the allowable voltage change rates S with respect to the respective electrical load devices E1 to En including, for example, the headlights 21 and the windshield wiper motor 31 mounted on the vehicle 10. The minimum allowable voltage Vmin and the maximum allowable voltage Vmax of the allowable voltage V are specified in advance with respect to each electrical load device as follows. With respect to the lighting devices such as the headlights 21, the minimum allowable voltage Vmin and the maximum allowable voltage Vmax of the allowable voltage V are specified in advance for each lighting device as the allowable variation range in which a feeling of strangeness on the basis of a fluctuation of light quantity (flicker) caused by a variation in lighting output is acceptable for the vehicle operator when the lighting device is turned on. With respect to the drive devices such as the windshield wiper motor 31, the minimum allowable voltage Vmin and the maximum allowable voltage Vmax of the allowable voltage V are specified in advance for each drive device as the allowable variation range in which a feeling of strangeness on the basis of a variation in driving speed of a drive object such as the windshield wipers W caused by a variation in motor output is acceptable for the vehicle operator when the drive object such as the windshield wipers W is driven by the drive device. With respect to the lighting devices such as the headlights 21, the allowable voltage change rate S of each lighting device as electrical load device is specified in advance as the allowable voltage change rate at which a feeling of strangeness on the basis of a fluctuation of light quantity (flicker) caused by a rate change of applied voltage is acceptable for the vehicle operator when the lighting device is turned on with the varying voltage applied to the lighting device. With respect to the drive devices such as the windshield wiper motor 31, the allowable voltage change rate S is specified in advance as the allowable voltage change rate at which a feeling of strangeness on the basis of a variation in driving speed of a drive object such as the windshield wipers W caused by a rate change of applied voltage is acceptable for the vehicle operator when the drive object such as the windshield wipers W is driven by the drive device.

After advanced storage of the minimum allowable voltages Vmin and the maximum allowable voltages Vmax of the allowable voltages V and the allowable voltage change rates S of the respective electrical load devices in the memory 210 as described above, the vehicle 10 of the embodiment identifies the output requesting electrical devices, for which the vehicle operator requires outputs, among the electrical load devices such as the headlights 21, in response to the vehicle operator's switch operations (steps S110 to S120). The vehicle 10 of the embodiment subsequently reads the minimum allowable voltages Vmin and the maximum allowable voltages Vmax of the allowable voltages V and the allowable voltage change rates S of the identified output requesting electrical load devices from the memory 210 (step S130), and calculates the overlap voltage range in which the read ranges of the allowable voltages V of the output requesting electrical load devices are overlapped, as the power generation voltage range Vp (step S135: shown in FIG. 6). The vehicle 10 of the embodiment then limits the power generation voltage of the generator 60 to the power generation voltage range Vp which is the overlap voltage range described above, and performs power generation control of the generator 60. The vehicle 10 of the embodiment specifies a lowest allowable voltage change rate S among the read allowable voltage change rates S of the respective output requesting electrical load devices as a change rate at which the power generation voltage of the generator 60 is varied and performs power generation control of the generator 60 at the specified changed rate (lowest allowable voltage change rate 5). As a result, the vehicle 10 of the embodiment applies the power generation voltage, which is limited to the power generation voltage range Vp as the above overlap voltage range, to the individual output requesting electrical load devices and thus enables output variations of the respective output requesting electrical load devices to be limited to respective allowable output variation ranges. This reduces a feeling of strangeness on the basis of the output variation with respect to all the output requesting electrical load devices. Additionally, during voltage change control of the generator 60, the vehicle 10 of the embodiment allows for a change in power generation voltage only at the lowest allowable voltage change rate S among the allowable voltage change rates S of the respective output requesting electrical load devices. This also reduces a feeling of strangeness on the basis of a change in output variation with respect to all the output requesting electrical load devices.

The vehicle 10 of the embodiment does not need any specific device for suppressing a variation in applied voltage on a power supply line arranged to connect the generator 60 with each of the output requesting electrical load devices such as the headlights 21. Accordingly the configuration of the vehicle 10 of the embodiment suppresses an increase in total number of parts and an increase in total weight and achieves cost reduction. The battery 70 is stably chargeable with the stable power generation voltage limited to the power generation voltage range Vp as the overlap voltage range (FIG. 6). This improves the availability ratio of charge control and, in combination with suppression of an increase in weight described above, improves the fuel consumption.

As described with reference to FIG. 7, unless there is any overlap of the read allowable voltages V of the respective output requesting electrical devices, the vehicle 10 of the embodiment sets the rated voltage range and the change rate suitable for the power generation performance of the generator 60 to the power generation voltage Vp of the generator 60 and the change rate Vs for voltage change control, irrespective of the read allowable voltages V and allowable voltage change rates S. Accordingly the vehicle 10 of the embodiment performs power generation control of the generator 60 with the rated voltage range and the change rate suitable for the power generation performance of the generator 60 and thereby reduces the load applied to the generator 60. Additionally, this reduces a feeling of strangeness on the basis of an output variation with respect to each output requesting electrical device having the range of the allowable voltage V consistent with the rated voltage range of the generator 60.

The following describes another embodiment. This embodiment is characterized by that the high-low priorities are determined for suppression of the output variation based on the functions of the respective electrical load devices such as the headlights 21. The headlights 21 serve to illuminate ahead of the vehicle and enhance the night-time visibility. It is accordingly desirable to suppress a variation in light quantity (flicker) as the output variation and reduce a feeling of strangeness on the basis of the variation in light quantity. The vehicle interior light 23 serves to provide a certain intensity of illumination in the vehicle interior where the vehicle operator is seated. It is accordingly desirable to suppress a variation in light quantity (flicker) as the output variation and reduce a feeling of strangeness on the basis of the variation in light quantity. The instrument illumination light 25 illuminates various meters and the like, and serves to ensure their visibility. It is accordingly desirable to suppress a variation in light quantity (flicker) as the output variation and reduce a feeling of strangeness on the basis of the variation in light quantity. The rear turn signal lamps 26, the brake lamps 27 and the tail lamps 28 are, on the other hand, located on the rear side of the vehicle, so that the vehicle operator does not, in general, visually recognize the lights of these lamps. These lamps on the rear side of the vehicle accordingly have less necessity for suppressing the variation in light quantity, compared with the headlights 21. The same applies to the front turn signal lamps 22. The door illumination lamps 24 are turned on, only accompanied with opening and closing operations of the doors. There is accordingly less necessity to suppress the variation in light quantity. The windshield wiper motor 31 serves to drive the windshield wipers W for removal of raindrops and enhance the visibility ahead of the vehicle. It is accordingly desirable to suppress a variation in driving speed of the windshield wipers W caused by an output variation of the windshield wiper motor 31 and reduce a feeling of strangeness on the basis of the variation in driving speed. The front blower motor 41 and the rear blower motor 42 serve to provide the air flow of the air blown to the vehicle interior where the vehicle operator is seated. It is accordingly desirable to suppress a variation in air flow and reduce a feeling of strangeness on the basis of the variation in air flow. By taking into account these factors, the embodiment determines the high and low priorities for suppression of the output variation. Table 1 shows the priorities set for the respective electrical load devices. The memory 210 stores these high-low priorities in relation to the allowable voltages V and the allowable voltage change rates S described above.

TABLE 1

| Device Type | Priority |
|---|---|
| Headlights | High |
| Vehicle interior light | High |
| Instrument illumination light | High |
| Door illumination lamps | Low |
| Front turn signal lamps | Low |
| Rear turn signal lamps | Low |
| Brake lamps | Low |
| Tail lamps | Low |
| Windshield wiper motor | High |
| Front blower motor | High |
| Rear blower motor | High |

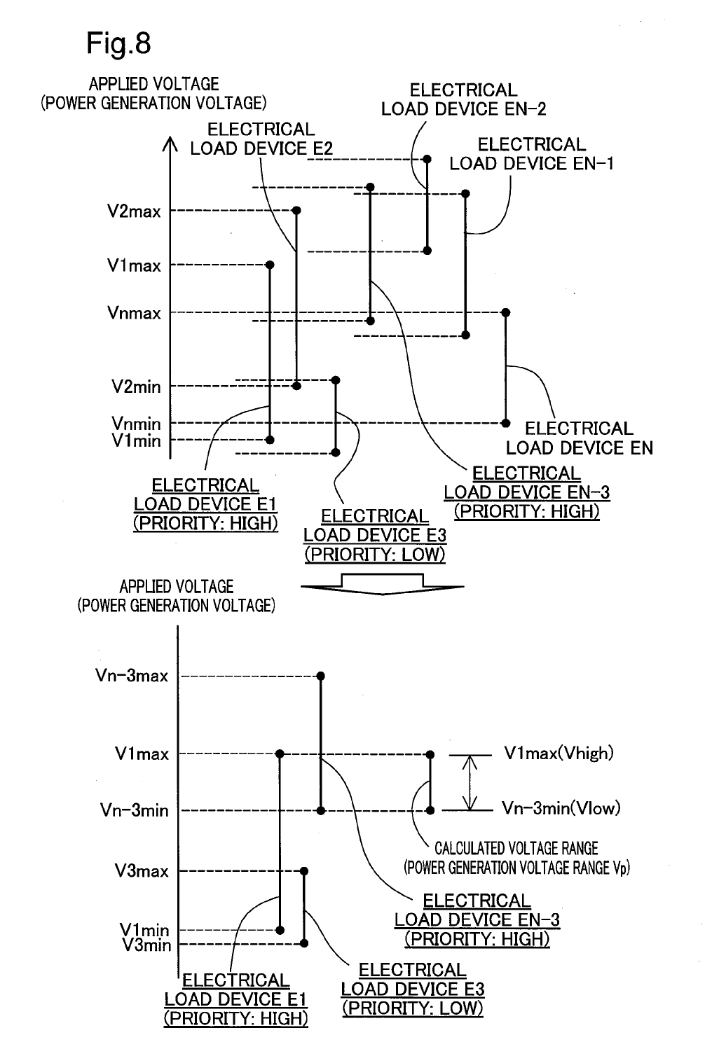

In the embodiment with setting the high-low priorities, when there is an overlap of the allowable voltages V read with respect to the output requesting electrical devices at step S135 in the power generation control process of FIG. 5, the processing of and after step S140 is performed. In response to a negative answer at step S135, i.e., when there is no overlap of the allowable voltages V, on the other hand, the power generation voltage range Vp is calculated by taking into account the priorities set in Table 1 as follows. FIG. 8 is diagrams illustrating calculation of an overlap of allowable voltage ranges in the embodiment that provides the high-low priorities for suppression of an output variation. In the illustrated example of FIG. 8, the electrical load device E1, the electrical load device E3 and the electrical load device EN−3 are identified as the output requesting electrical devices. The higher priority for suppression of an output variation is set to the electrical load device E1 and the electrical load device EN−3, while the lower priority is set to the electrical load device E3.

In the state of FIG. 8, as shown by the lower diagram, there is no overlap of the ranges of the overlap voltages V read with respect to the electrical load device E1, the electrical load device E3 and the electrical load device EN−3 identified as the output requesting electrical devices. Accordingly, the controller 200 reads the priorities of these output requesting electrical devices from the memory 210, excludes the electrical load device E3 having the low priority, and calculates an overlap range of the allowable voltages V of the electrical load device E1 and the electrical load device EN−3 as the power generation voltage range Vp. The power generation voltage range Vp is determined by setting the lower limit Vlow to the larger minimum allowable voltage Vn−3 min between the minimum allowable voltages Vmin of the allowable voltages V of the electrical load device E1 and the electrical load device EN−3 and setting the upper limit Vhigh to the smaller maximum allowable voltage V1max between the maximum allowable voltages Vmax of the allowable voltages V of the electrical load device E1 and the electrical load device EN−3. The range from the lower limit Vlow (=minimum allowable voltage Vn−3 min) to the upper limit Vhigh (=maximum allowable voltage V1max) is specified as the power generation voltage range Vp. Similarly, the lower allowable voltage change rate S between the allowable voltage change rates S read with respect to the electrical load device E1 and the electrical load device EN−3 having the high priorities is specified as the change rate Vs. The embodiment with setting the high-low priorities effectively reduces a feeling of strangeness on the basis of an output variation with respect to the electrical load devices having the high priorities for suppression of the output variation or more specifically the headlights 21 and the windshield wiper motor 31 shown in Table 1.

The invention is not limited to any of the embodiments described herein but may be implemented by a diversity of other configurations without departing from the scope of the invention. For example, the technical features of any of the embodiments corresponding to the technical features of the respective aspects described in Summary may be replaced or combined appropriately, in order to solve part or all of the problems described above or in order to achieve part or all of the advantageous effects described above. Any of the technical features may be omitted appropriately unless the technical feature is described as essential in the description hereof.

The embodiments described above calculates the power generation voltage range Vp as shown in FIG. 6 and limits the power generation voltage of the generator 60 to the range of the lower limit Vlow and the upper limit Vhigh. Alternatively the power generation voltage of the generator 60 may be limited to a partial range included in the power generation voltage range Vp of the lower limit Vlow and the upper limit Vhigh.

The above embodiment sets the two different levels of priorities, i.e., the high and low priorities, to be taken into account for suppression of an output variation. One modification may, however, set three or more different levels of priorities and sequentially exclude an electrical load device having the lower priority from the object of calculation of an overlap range of the allowable voltages V.

The above embodiments specify the allowable voltage change rate S for each electrical load device. Like the allowable voltage V, however, the allowable voltage change rate S may be specified as a range between a minimum allowable change rate Smin and a maximum allowable change rate Smax. After specification of this range, during voltage change control of the generator 60, power generation control of the generator 60 may be performed with limiting a change rate of the power generation voltage to the range of the lowest allowable voltage change rate S among the allowable voltage change rates S of the output requesting electrical load devices.

### REFERENCE SIGNS LIST

10 vehicle
21 headlights
22 front turn signal lamps
23 vehicle interior light
24 door illumination lamps
25 instrument illumination light
26 rear turn signal lamps
27 brake lamps
28 tail lamps
31 windshield wiper motor
41 front blower motor
42 rear blower motor
60 generator
62 engine
64 rotation transmission device
66 charge/power feed device
70 battery
72 battery sensor
80 group of output request switches
120 lighting device group
122 lighting device relay box
130 first drive device group
132 first drive device relay box
140 second drive device group
142 second drive device relay box
200 controller
210 memory
220 electrical load input adjuster
221 output request object identifier
222 lamp lighting determiner
223 windshield wiper operation determiner
224 blower operation determiner
225 voltage overlap range calculator
226 non-adjustment determiner
230 generator voltage command provider
240 input-output port
250 bus
W windshield wiper
Bf front blower
Br rear blower

1. A power generation control apparatus for a generator, comprising:
a plurality of electrical load devices to which a power generation voltage of the generator is applied, respectively;
a storage unit configured to store an allowable voltage range set for each of the electrical load devices as a range in which voltage application to the electrical load device is allowed;
a device identifier configured to identify each application object electrical load device as an object of voltage application, among the plurality of electrical load devices;
an overlap range calculator configured to read the allowable voltage range of each identified application object electrical load device from the storage unit and calculate an overlap voltage range in which the read allowable voltage ranges of the application object electrical load devices are overlapped; and
a power generation controller configured to limit the power generation voltage of the generator to the overlap voltage range and perform power generation control of the generator.

2. The power generation control apparatus for the generator according to claim 1,
wherein in the event the overlap range calculator is unable to calculate of the overlap voltage range, the power generation controller limits the power generation voltage of the generator to a predetermined voltage range and performs power generation control of the generator.

3. The power generation control apparatus for the generator according to claim 1,
wherein the storage unit stores a priority for suppression of an output variation set with respect to each of the electrical load devices, and
in the event the overlap range calculator is unable to calculate the overlap voltage range, the overlap range calculator reads the priority set for each identified application object electrical load device from the storage unit, excludes the application object electrical load device having a low priority from calculation of the overlap voltage range and calculates the overlap voltage range.

4. A power generation control apparatus for a generator, comprising:
a plurality of electrical load devices to which a power generation voltage of the generator is applied, respectively;
a storage unit configured to store a change rate range of allowable voltage set for each of the electrical load devices as a range in which application of varying voltage to the electrical load device is allowed;
a device identifier configured to identify each application object electrical load device as an object of voltage application, among the plurality of electrical load devices;
a low change rate range selector configured to read the change rate range of allowable voltage with respect to each identified application object electrical load device from the storage unit and select a lowest change rate range among the read change rate ranges of allowable voltage of the application object electrical load devices, as a selected change rate range; and
a power generation controller configured to limit a change rate of the power generation voltage of the generator to the selected change rate range and perform power generation control of the generator.

5. A power generation control method of a generator, comprising steps of:
(1) identifying each application object electrical load device as an object of voltage application, among a plurality of electrical load devices to which a power generation voltage of the generator is applied, respectively;
(2) reading an allowable voltage range of each application object electrical load device identified in the step (1) from a storage unit configured to store the allowable voltage range set for each of the electrical load devices as a range in which voltage application to the electrical load device is allowed, and calculating an overlap voltage range in which the read allowable voltage ranges of the application object electrical load devices are overlapped; and
(3) limiting the power generation voltage of the generator to the overlap voltage range calculated in step (2) and performing power generation control of the generator.
